(19) United States
(12) Patent Application Publication
(10) Pub. No.: US 2017/0058831 A1
(43) Pub. Date: Mar. 2, 2017

(54) GAS TURBINE ENGINE HAVING RADIALLY-SPLIT INLET GUIDE VANES

(71) Applicants: William Barry Bryan, Indianapolis, IN (US); Edward C. Rice, Inianapolis, IN (US); Douglas David Dierksmeier, Franklin, IN (US); Kyle Jameson Martin, McCordsville, IN (US); Charles L. McNeil, Monrovia, IN (US)

(72) Inventors: William Barry Bryan, Indianapolis, IN (US); Edward C. Rice, Inianapolis, IN (US); Douglas David Dierksmeier, Franklin, IN (US); Kyle Jameson Martin, McCordsville, IN (US); Charles L. McNeil, Monrovia, IN (US)

(21) Appl. No.: 14/837,031

(22) Filed: Aug. 27, 2015

(51) Int. Cl. F02K 3/075; F01D 17/14; F01D 9/04; F01D 17/10; F02C 3/04; F02K 3/06

(52) U.S. Cl. CPC F02K 3/075; F02C 3/04; F02K 3/06; F01D 9/041; F01D 17/105; F01D 17/14; F05D 2220/36; F05D 2240/35; F05D 2260/606

(57) ABSTRACT

An apparatus for the control of fluid flow in a gas turbine engine comprises a first plurality of inlet guide vanes disposed upstream of a fan, a compressor, a combustor, and a turbine; at least one airflow splitter adapted to split air admitted through the first plurality of inlet guide vanes into a core airflow which flows through the fan, the compressor, the combustor, and the turbine and a bypass airflow which flows through the fan; wherein the first plurality of inlet guide vanes comprise a radially-inward first portion adapted to direct air admitted through the first plurality of inlet guide vanes to the core airflow and a radially-outward second portion adapted to direct air admitted through the first plurality of inlet guide vanes to the bypass airflow, and wherein the first portion comprises a fixed vane and the second portion comprises a variable vane.

### RELATED APPLICATIONS

This application is related to concurrently filed and co-pending applications U.S. patent application Ser. No. ______ entitled “Splayed Inlet Guide Vanes”; U.S. patent application Ser. No. ______ entitled “Morphing Vane”; U.S. patent application Ser. No. ______ entitled “Propulsive Force Vectoring”; U.S. patent application Ser. No. ______ entitled “A System and Method for a Fluidic Barrier on the Low Pressure Side of a Fan Blade”; U.S. patent application Ser. No. ______ entitled “Integrated Aircraft Propulsion System”; U.S. patent application Ser. No. ______ entitled “A System and Method for a Fluidic Barrier from the Upstream Splitter”; U.S. patent application Ser. No. ______ entitled “A System and Method for a Fluidic Barrier with Vortices from the Upstream Splitter”; U.S. patent application Ser. No. ______ entitled “A System and Method for a Fluidic Barrier from the Leading Edge of a Fan Blade.” The entirety of these applications are incorporated herein by reference.

### FIELD OF THE DISCLOSURE

The present disclosure generally relates to systems used to control fluid flow rate. More specifically, the present disclosure is directed to systems which use articulating vanes to control fluid flow rate.

### BACKGROUND

Fluid propulsion devices achieve thrust by imparting momentum to a fluid called the propellant. An air-breathing engine, as the name implies, uses the atmosphere for most of its propellant. The gas turbine produces high-temperature gas which may be used either to generate power for a propeller, fan, generator or other mechanical apparatus or to develop thrust directly by expansion and acceleration of the hot gas in a nozzle. In any case, an air breathing engine continuously draws air from the atmosphere, compresses it, adds energy in the form of heat, and then expands it in order to convert the added energy to shaft work or jet kinetic energy. Thus, in addition to acting as propellant, the air acts as the working fluid in a thermodynamic process in which a fraction of the energy is made available for propulsive purposes or work.

Typically turbofan engines include at least two air streams. All air utilized by the engine initially passes through a fan, and then it is split into the two air streams. The inner air stream is referred to as core air and passes into the compressor portion of the engine, where it is compressed. This core air then is fed to the combustor portion of the engine where it is mixed with fuel and the fuel is combusted. The combustion gases then are expanded through the turbine portion of the engine, which extracts energy from the hot combustion gases, the extracted energy being used to run the compressor, the fan and other accessory systems. The remaining hot gases then flow into the exhaust portion of the engine, which may be used to produce thrust for forward motion to the aircraft.

The outer air flow stream bypasses the engine core and is pressurized by the fan. Typically, no other work is done on the outer air flow stream which continues axially down the engine but outside the core. The bypass air flow stream also can be used to accomplish aircraft cooling by the introduction of heat exchangers in the fan stream. Downstream of the turbine, the outer air flow stream is used to cool engine hardware in the exhaust system. When additional thrust is required (demanded), some of the fan bypass air flow stream may be redirected to the augmenter (afterburner) where it is mixed with core flow and fuel to provide the additional thrust to move the aircraft.

Many current and most future aircraft need efficient installed propulsion system performance capabilities at diverse flight conditions and over widely varying power settings for a variety of missions. Current turbofan engines are limited in their capabilities to supply this type of mission adaptive performance, in great part due to the fundamental operating characteristics of their core systems which has limited flexibility in load shifting between shaft and fan loading.

When defining a conventional engine cycle and configuration for a mixed mission application, compromises have to be made in the selection of fan pressure ratio, bypass ratio, and overall pressure ratio to allow a reasonably sized engine to operate effectively. In particular, the fan pressure ratio and related bypass ratio selection needed to obtain a reasonably sized engine capable of developing the thrusts needed for combat maneuvers are non-optimum for efficient low power flight where a significant portion of the engine output is transmitted to the shaft. In some applications, it is desired to reduce engine thrust in order to transfer power to a shaft which drives a lift rotor, propeller, generator, or other device or system external to the turbofan engine.

Referring to the drawings wherein identical reference numerals denote the same elements throughout the various views, FIG. 1A shows a general orientation of a turbofan engine in a cut away view. In the turbofan engine shown the flow of the air is generally axial. The engine direction along the axis is generally defined using, the terms “upstream” and “downstream” generally which refer to a position in a jet engine in relation to the ambient air inlet and the engine exhaust at the back of the engine. For example, the inlet fan is upstream of the combustion chamber. Likewise, the terms “fore” and “aft” generally refer to a position in relation to the ambient air inlet and the engine exhaust nozzle. Additionally, outward/outboard and inward/inboard refer to the radial direction. For example the bypass duct is outboard the core duct. The ducts are generally circular and co-axial with each other.

As ambient inlet airflow 12 enters inlet fan duct 14 of turbofan engine 10, through the guide vanes 15 and passes by fan spinner 16, through fan rotor (fan blade) 42. The airflow 12 is split into primary (core) flow stream 28 and bypass flow stream 30 by upstream splitter 24 and downstream splitter 25. In FIG. 2, the bypass flow stream 30 along with the core/primary flow stream 28 is shown, the bypass stream 30 being outboard of the core stream 28. The inward portion of the bypass steam 30 and the outward portion of the core streams are partially defined by the splitters upstream of the compressor 26. The fan 42 has a plurality of fan blades.

As shown in FIGS. 1A and 1B the fan blade 42 shown is rotating about the engine axis into the page, therefor the low pressure side of the blade 42 is shown, the high pressure side being on the opposite side. The primary flow stream 28 flows through compressor 26 that compresses the air to a higher pressure. The compressed air typically passes through an outlet guide vane to straighten the airflow and eliminate swirling motion or turbulence, a diffuser where air spreads out, and a compressor manifold to distribute the air in a smooth flow. The core flow stream 28 is then mixed with fuel in combustion chamber 36 and the mixture is ignited and burned. The resultant combustion products flow through turbines 38 that extract energy from the combustion gases to turn fan rotor 42, compressor 26 and any shaft work by way of turbine shaft 40. The gases, passing exhaust cone, expand through an exhaust nozzle 43 to produce thrust. Primary flow stream 28 leaves the engine at a higher velocity than when it entered. Bypass flow stream 30 flows through fan rotor 42, flows by bypass duct outer wall 27, an annular duct concentric with the core engine, flows through fan discharge outlet and is expanded through an exhaust nozzle to produce additional thrust. Turbofan engine 10 has a generally longitudinally extending centerline represented by engine axis 46.

A typical turbofan engine employs a two-shaft design, with a high-pressure turbine and the compressor 26 connected via a first shaft and a low-pressure turbine and the fan blade 42 connected via a second shaft. In most designs the first and second shafts are concentrically located.

In most turbofan engines a significant portion of the engine's thrust is produced by the rotation of fan blades 42 to create airflow in the bypass stream 30. However, as noted above in some applications it is desirable to reduce an engine's thrust in order to transfer power to other systems, devices, or applications. Thus, an effective means is needed to reduce a turbofan engine's thrust while maintaining overall power produced by the core.

These and many other advantages of the present subject matter will be readily apparent to one skilled in the art to which the invention pertains from a perusal of the claims, the appended drawings, and the following detailed description of preferred embodiments.

The present application discloses one or more of the features recited in the appended claims and/or the following features which, alone or in any combination, may comprise patentable subject matter.

According to an aspect of the present disclosure, a gas turbine engine is provided which comprises an air inlet; at least one airflow splitter adapted to split an inlet airflow into a bypass airflow and a core airflow which flows through a core comprising a compressor, a combustor, and a turbine, wherein the bypass airflow bypasses the core; a fan disposed between the air inlet and, the core; wherein the air inlet comprises a plurality of radially-split inlet guide vanes comprising a fixed portion and a variable portion, the fixed portion directing inlet airflow into the core airflow and the variable portion controlling the flow rate of inlet airflow into the bypass airflow. In some embodiments the fixed portion is radially-inward from the variable portion and the variable portion is radially-outward from the fixed portion. In some embodiments the variable portion is continuously variable between a full turbothrust position and a full turboshaft position. In some embodiments the engine further comprises an actuator adapted to vary the orientation of the variable portion wherein the actuator is adapted to reduce the bypass airflow while maintaining a constant core airflow. In some embodiments the engine further comprises a set of radially-split guide vanes disposed aft of the plurality of radially-split inlet guide vanes. In some embodiments the engine further comprises a shaft connected between the turbine and one or more of a lift rotor, a propeller or a generator. In some embodiments altering the variable portion to reduce bypass airflow transfers power from thrust to the shaft connected between the turbine and one or more of a lift rotor, a propeller or a generator.

According to another aspect of the present disclosure, an apparatus is provided for the control of fluid flow in a gas turbine engine. The apparatus comprises a first plurality of inlet guide vanes disposed upstream of a fan, a compressor, a combustor, and a turbine; at least one airflow splitter adapted to split air admitted through the first plurality of inlet guide vanes into a core airflow which flows through the fan, the compressor, the combustor, and the turbine and a bypass airflow which flows through the fan; wherein the first plurality of inlet guide vanes comprise a radially-inward first portion adapted to direct air admitted through the first plurality of inlet guide vanes to the core airflow and a radially-outward second portion adapted to direct air admitted through the first plurality of inlet guide vanes to the bypass airflow, and wherein the first portion comprises a fixed vane and the second portion comprises a variable vane. In some embodiments the apparatus further comprises an actuator adapted to adjust the position of the second portion. In some embodiments the variable vane comprises a fixed strut and a rotatable flap, and wherein the orientation of the variable vane is varied by articulating the rotatable flap relative to the fixed strut. In some embodiments the variable vane comprises an airfoil and the orientation of the variable vane is varied by articulating the airfoil about a radial axis thereof. In some embodiments a protrusion extends from the radially-outward second portion into the radially-inward first portion to provide a point of articulation for the radially-outward second portion. In some embodiments the fan is a two-stage fan comprising an upstream set of fan blade and a downstream set of fan blades. In some embodiments the apparatus further comprises a second plurality of radially-split inlet guide vanes disposed downstream from the upstream set of fan blades and upstream from the downstream set of fan blades. In some embodiments the apparatus further comprises a second plurality of radially-split inlet guide vanes disposed downstream from the upstream set of fan blades and the downstream set of fan blades.

According to another aspect of the present disclosure, a method is provided for altering the thrust of a gas turbine engine having a core flowpath through an air inlet, a fan, a compressor, a combustor, and a turbine and a bypass flowpath through the air inlet and the fan. The method comprises the steps of admitting a first volumetric flow rate of air into the core flowpath via a first portion of the air inlet comprising a plurality of fixed vanes; admitting a second volumetric flow rate of air into the bypass flowpath via a second portion of the air inlet comprising a plurality of variable vanes; and altering the inlet geometry of the plurality of variable vanes to alter the second volumetric flow rate of air admitted into the bypass flowpath while maintaining the first volumetric flow rate of air admitted into the core flowpath constant. In some embodiments the plurality of variable vanes are continuously variable between a first fully powered position and a second fully depowered position. In some embodiments the step of altering the inlet geometry comprises manipulating an actuator connected to the plurality of variable vanes causing a reduction in the second volumetric flow rate of air admitted into the bypass flowpath. In some embodiments the gas turbine engine is affixed to an aircraft and wherein the step of altering the inlet geometry is performed as the aircraft transitions between horizontal and vertical modes of flight. In some embodiments the method step of altering the inlet geometry further comprises the steps of coarsely adjusting the second volumetric flow rate of air admitted into the bypass flowpath; and finely adjusting the second volumetric flow rate of air admitted into the bypass flowpath.

### BRIEF DESCRIPTION OF THE DRAWINGS

The following will be apparent from elements of the figures, which are provided for illustrative purposes and are not necessarily to scale.

FIGS. 1A and 1B are cutaway perspective views of typical turbofan engines.

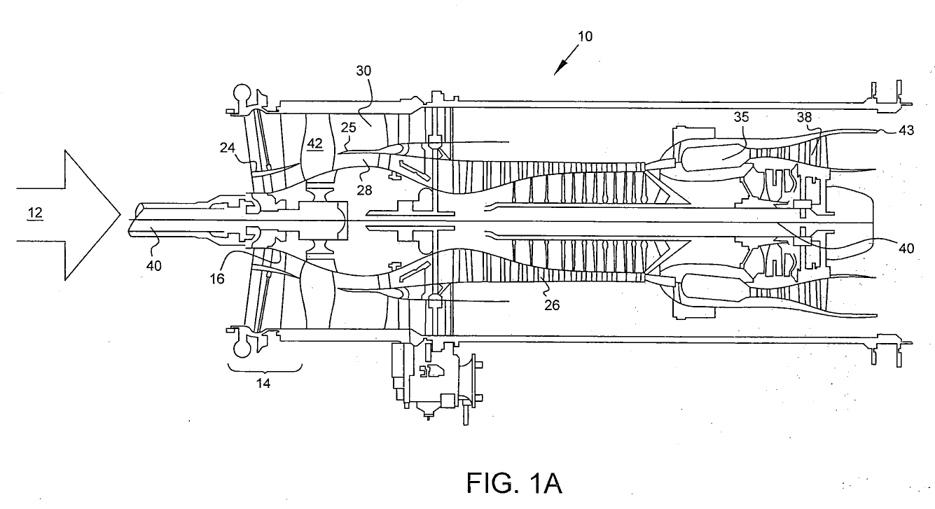

FIG. 2 is an illustration of the bypass and core airflow paths in a typical turbofan engine.

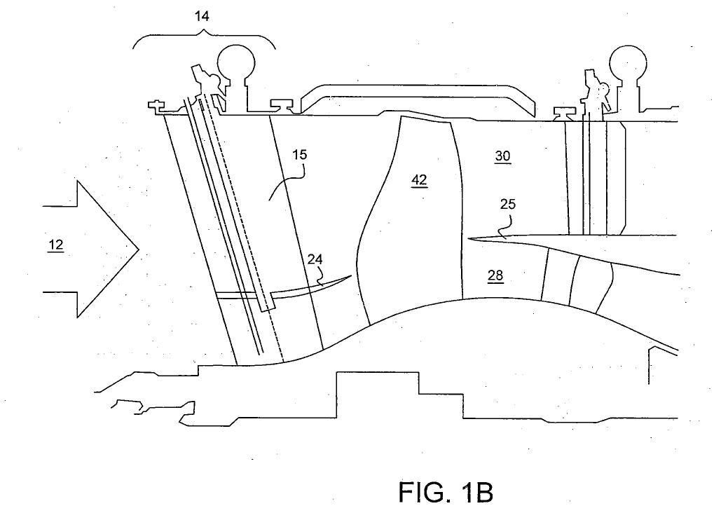

FIGS. 3A and 3B are cutaway perspective views of a turbofan engine with a radially-split inlet guide vane in accordance with some embodiments of the present disclosure.

FIG. 4 is a profile view of a variable portion of a radially-split inlet guide vane in accordance with some embodiments of the present disclosure.

FIG. 5 is a profile view of a variable portion of a radially-split inlet guide vane in accordance with some embodiments of the present disclosure.

FIG. 6 is a cutaway perspective view of a turbofan engine with a radially-split inlet guide vane in accordance with some embodiments of the present disclosure.

FIG. 7 is a cutaway perspective view of a turbofan engine with a radially-split inlet guide vane in accordance with some embodiments of the present disclosure.

FIG. 8 is an isometric view of turbofan engine having radially-split inlet guide vanes in accordance with some embodiments of the present disclosure.

FIG. 9 is an isometric view of turbofan engine having radially-split inlet guide vanes in accordance with some embodiments of the present disclosure.

FIG. 10 is a flow diagram of a method in accordance with some embodiments of the present disclosure.

FIG. 11 is a flow diagram of a method in accordance with some embodiments of the present disclosure.

FIG. 12 is a cutaway perspective view of a turbofan engine with a two-stage fan and two sets of radially-split inlet guide vanes in accordance with some embodiments of the present disclosure.

FIG. 13 is a cutaway perspective view of a turbofan engine with a radially-split inlet guide vane located downstream of the fan in accordance with some embodiments of the present disclosure.

FIG. 14 is a cutaway perspective view of a turbofan engine with two sets of radially-split inlet guide vanes in accordance with some embodiments of the present disclosure.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

For the purposes of promoting an understanding of the principles of the disclosure, reference will now be made to a number of illustrative embodiments illustrated in the drawings and specific language will be used to describe the same.

This disclosure presents embodiments to overcome the aforementioned deficiencies of conventional turbofan engines. More specifically, this disclosure is directed to an air inlet of a turbofan engine comprising a plurality radially-split inlet guide vanes having a first fixed portion to control airflow into the engine core and a second variable portion to control airflow into the engine bypass. The disclosed air inlet thus enables a turbofan engine to significantly reduce its thrust output by reducing the bypass airflow through the variable portion while maintaining overall engine power output by maintaining a constant volume of core airflow through the fixed portion. Engine power can be transferred from thrust to other applications such as a lift fan, propeller, generator, or other device or system.

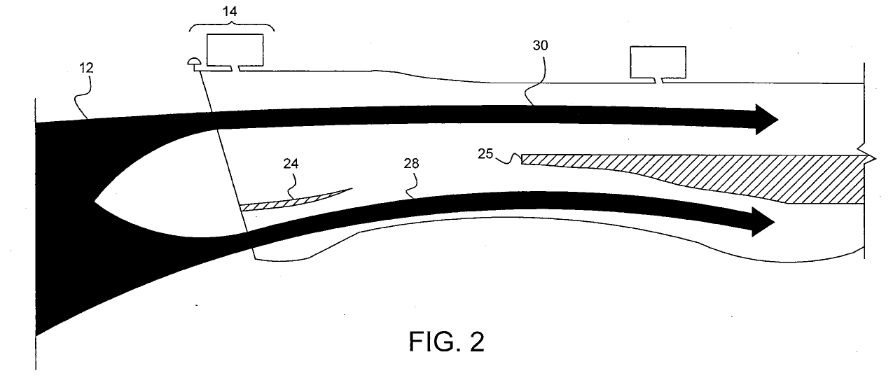

FIG. 3A is a cutaway perspective view of a turbofan engine 10 having a radially-split inlet guide vane 50. As described above, turbofan engine 10 has an inlet fan duct 14 leading to a fan blade 42. A downstream splitter 25 divides air entering the turbofan engine 10 into a core flow stream 28 and a bypass flow stream 30. A single radially-split inlet guide vane 50 is illustrated; a plurality of such vanes 50 are arranged circumferentially around the centerline axis for directing and controlling airflow entering turbofan engine 10.

Each vane 50 comprises a pair of lateral major surfaces forming a leading and a trailing edge. As illustrated in FIG. 3A, in some embodiments a radially-split inlet guide vane 50 comprises a first portion 51 and second portion 52. In some embodiments the first portion 51 is disposed radially inward from the second portion 52. The first portion 51 directs air onto fan blade 42 and then into core flow stream 28. In some embodiments the first portion 51 comprises a fixed blade. The second portion 52 is disposed radially outward from the first portion 51, and directs air onto fan blade 42 and then into bypass flow stream 30.

FIG. 3A additionally illustrates an actuator 54 connected to second portion 52. The actuator 54 is adapted to vary the position of second portion 52, thus altering the geometry of the inlet fan duct 14. In some embodiments a stem 56 extends from its connection with the actuator 54 through second portion 52 and into first portion 51, thus providing two articulating points for second portion 52. Stem 56 may provide the axis of articulation 53, which may be located at the aerodynamic center of second portion 52 or may be located offset from the aerodynamic center. In some embodiments the actuator 54 is an actuation ring disposed transverse to the direction of airflow 12 and radially outward from vane 50. An actuation ring is connected to each second portion 52 of the plurality of radially-split inlet guide vanes 50 such that movement of the actuation ring causes articulation of each second portion 52.

FIG. 3B illustrates a second embodiment of radially-split inlet guide vane 50 having a lower protrusion 31 extending from second portion 52 into first portion 51 and an upper protrusion 32 extending from second portion 52 into a turbine casing 33. Upper protrusion 32 and lower protrusion 31 provide articulating points for second portion 52. An axis of articulation 53 is defined through upper protrusion 32 and lower protrusion 32. Actuator 54 is connected to second portion 52 via upper protrusion 32. In some embodiments either upper protrusion 32 or lower protrusion 31 is omitted and second portion 52 has a single point of articulation.

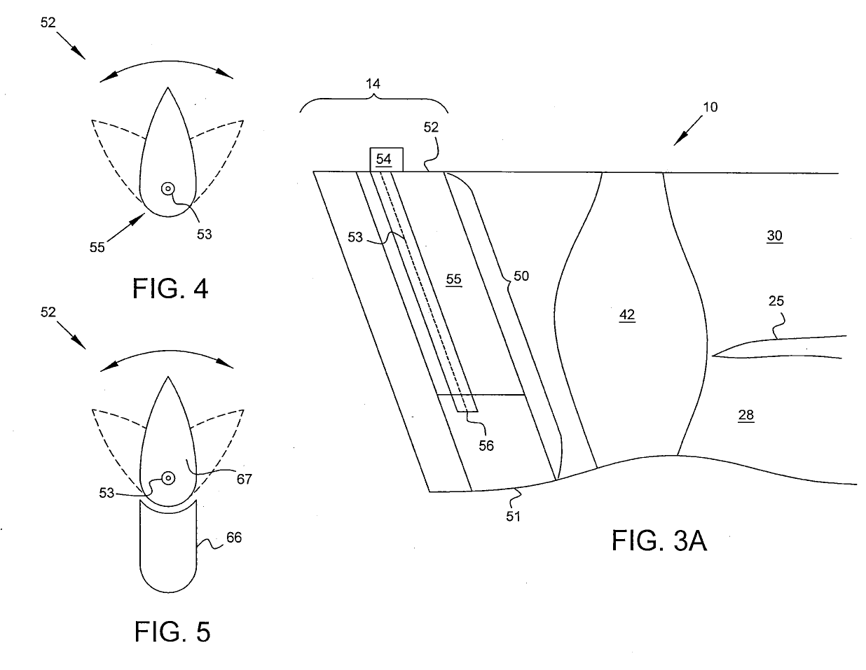

In some embodiments such as those illustrated in FIGS. 3A and 3B second portion 52 comprises a unitary member 55 which rotates about an axis of articulation 53. FIG. 4 is a profile view of such a second portion 52, illustrating the range of motion of a unitary member 55.

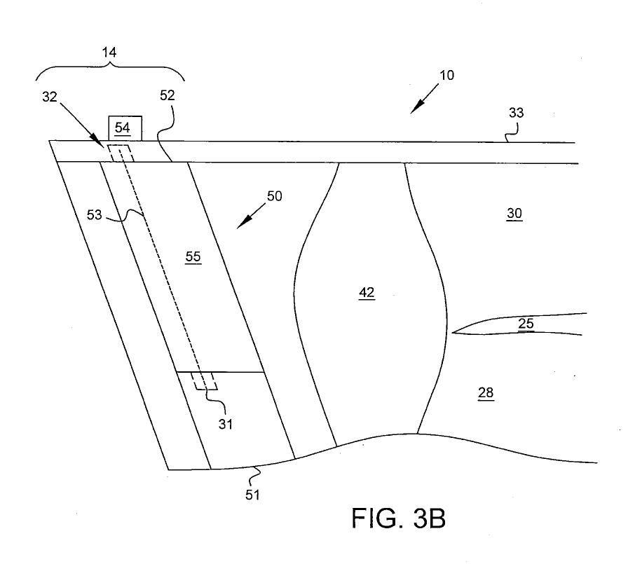

In some embodiments such as those illustrated in FIGS. 3A and 3B second portion 52 can comprise a fixed strut 66 and a rotatable flap 67. FIG. 5 is a profile view of one such embodiment which illustrates the range of motion of rotatable flap 67. As shown in FIG. 5, fixed strut 66 is disposed upstream from rotatable flap 67, which articulates about axis of articulation 53.

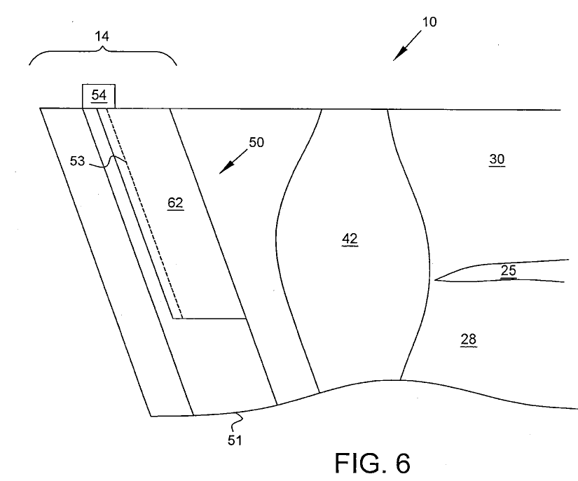

FIG. 6 is a cutaway perspective view of a turbofan engine 10 having a radially-split inlet guide vane 50 of a different configuration than that illustrated in FIG. 3. Specifically, in FIG. 6 the radially-split inlet guide van 50 comprises a unitary fixed portion 61 and a variable portion 62. The fixed portion 61 extends radially across the inlet fan duct 14, providing a fixed vane upstream from core flow stream 28 and the fixed strut portion of the variable van upstream from bypass flow stream 30. Variable portion 62 is connected to actuator 54 and articulates about an axis of articulation 53. In profile view, vane 50 illustrated in FIG. 6 would appear similar to the second portion 52 illustrated in FIG. 5, having a fixed strut (the fixed portion 61) and rotatable flap (the variable portion 62).

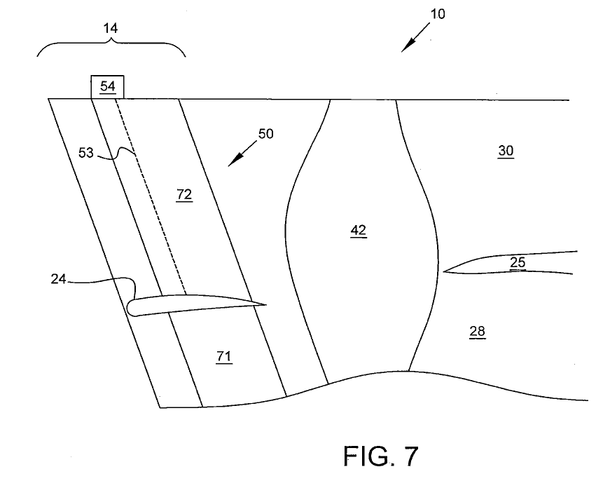

FIG. 7 is a cutaway perspective view of a turbofan engine 10 having a radially-split inlet guide vane 50 of a different configuration than that illustrated in FIG. 3. Specifically, in FIG. 7 the radially-split inlet guide vane 50 comprises a first portion 71 and second portion 72 which are separated by an integral upstream splitter 24. As with previous embodiments, first portion 71 is radially inward from second portion 72 and is fixed. Second portion 72 is variable. In some embodiments second portion 72 is a unitary airfoil which rotates about an axis of articulation 53, while in other embodiments second portion 72 comprises a fixed strut and rotatable flap. Upstream splitter 24 assists the radially-split inlet guide vane 50 and downstream splitter 25 in dividing inlet air into a bypass flow stream 30 and core flow stream 28.

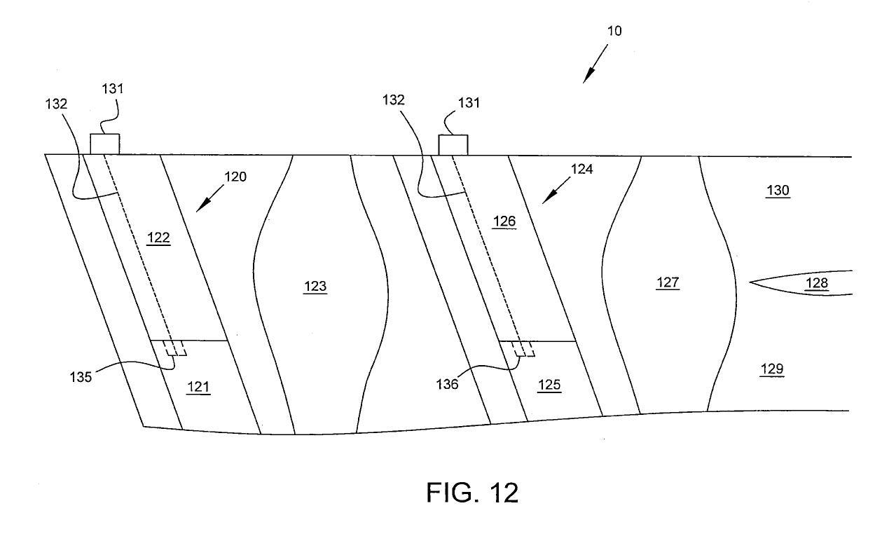

FIG. 12 is a cutaway perspective view of a turbofan engine 10 having a two-stage fan comprising an upstream blade 123 and downstream blade 127, as well as two sets of radially-split guide vanes comprising upstream guide vane 120 and downstream guide vane 124. Upstream guide vane 120 is located upstream of upstream fan blade 123, and comprises a first portion 121 and second portion 122 as described above with reference to FIG. 3A, 3B, 6, or 7. Downstream guide vane 124 is located downstream of upstream fan blade 123 and upstream of downstream fan blade 127. Downstream guide vane comprises a first portion 125 and second portion 126 as described above with reference to FIG. 3A, 3B, 6, or 7. First portions 121 and 125 are fixed while second portions 122 and 126 are variable. A first actuator 131 is connected to upstream guide vane 120 which articulates about an axis 132. A second actuator is connected to downstream guide vane 124 which articulates about an axis 134. As illustrated in FIG. 12, upstream guide vane 120 and downstream guide vane 124 have a single articulating point of protrusion 135 and 136, respectively. However, in other embodiments upstream guide vane 120 and downstream guide vane 124 can be designed as described above with reference to the radially-split inlet guide vane 50 disclosed in FIG. 3A, 3B, 6, or 7. A downstream splitter 128 is located downstream from the downstream guide vane 124 and divides the core flow path 129 from bypass flow path 130.

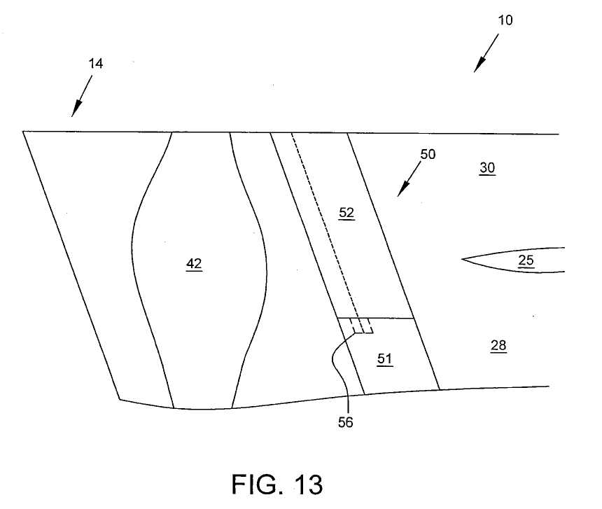

FIG. 13 is a cutaway perspective view of yet another configuration of a turbofan engine 10 having a set of radially-split inlet guide vanes 50 located downstream of fan blade 42. Inlet fan duct 14 directs air to fan blade 42. Radially-split inlet guide vane 50 is illustrated as having a single point of articulation of protrusion 56 which extends from second portion 52 into first portion 51. Second portion 52 is variable while first portion 51 is fixed. In other embodiments radially-split inlet guide vane 50 can be designed as described above with reference to the radially-split inlet guide vane 50 disclosed in FIG. 3A, 3B, 6, or 7. A downstream splitter 25 divides core flow path 28 from bypass flow path 30.

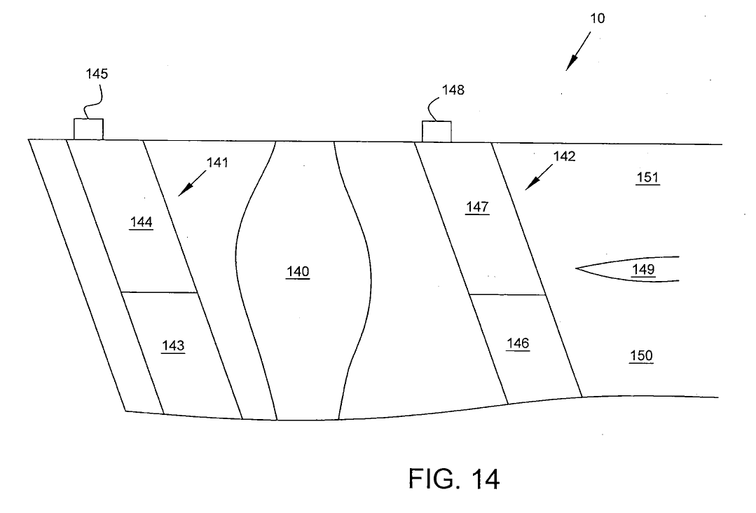

FIG. 14 is a cutaway perspective view of still another configuration of a turbofan engine 10. In FIG. 14, turbofan engine 10 comprises a single stage fan illustrated as fan blade 140, an upstream radially-split guide vane 141 located upstream from fan blade 140, and a downstream radially-split guide vane 142 located downstream from fan blade 142. Upstream radially-split guide vane 141 comprises a first fixed portion 143 and second variable portion 144 which is connected to a first actuator 145. Downstream radially-split guide vane 142 comprises a first fixed portion 146 and second variable portion 147 which is connected to a first actuator 148. A downstream splitter 149 divides core flow path 150 from bypass flow path 151. Upstream radially-split guide vane 141, downstream radially-split guide vane 142, and the downstream splitter 149 collectively control and direct air flow into core flow path 150 and bypass flow path 151. Upstream radially-split guide vane 141 and downstream radially-split guide vane 142 can be designed as described above with reference to the radially-split inlet guide vane 50 disclosed in FIG. 3A, 3B, 6, or 7.

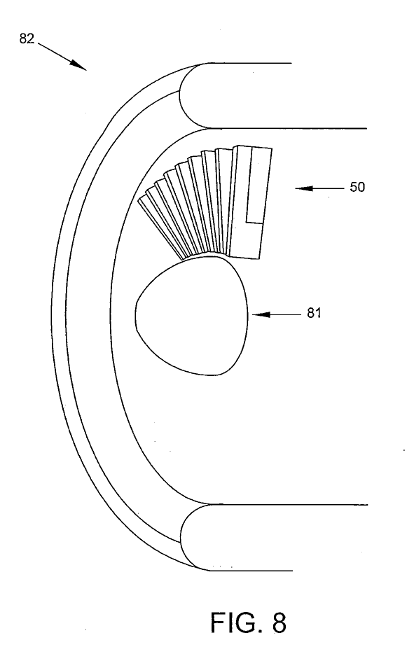

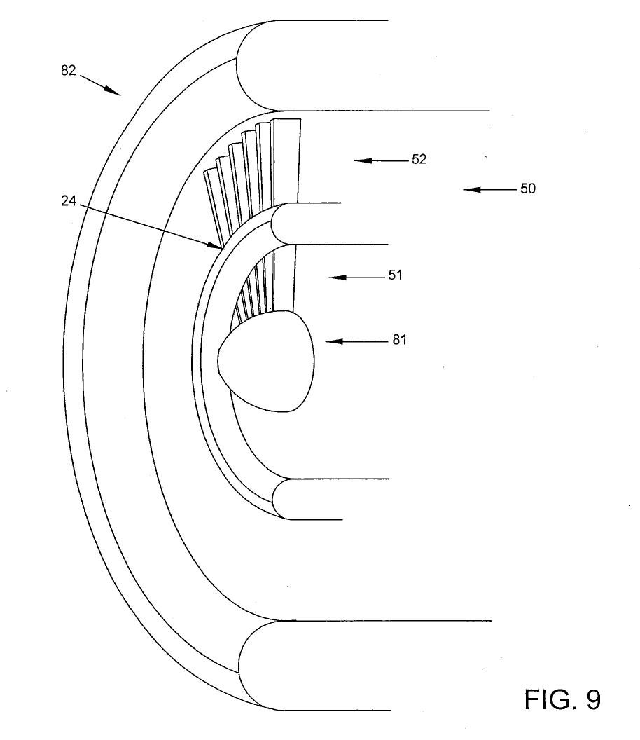

FIGS. 8 and 9 are isometric views of a turbofan engine 10 having a plurality of radially-split inlet guide vanes 50. As both FIG. 8 and FIG. 9 show, a plurality of radially-split inlet guide vanes 50 extend radially outward from a centerline axis 81 and are radially contained by nacelle 82. FIG. 8 illustrates radially-split inlet guide vanes 50 independent of an upstream splitter 24 and having fixed and variable portions configured as illustrated in FIG. 6. FIG. 9 illustrates radially-split inlet guide vanes 50 integral to an upstream splitter 24 and having a fixed first portion 51 and variable second portion 52 as illustrated in FIG. 7.

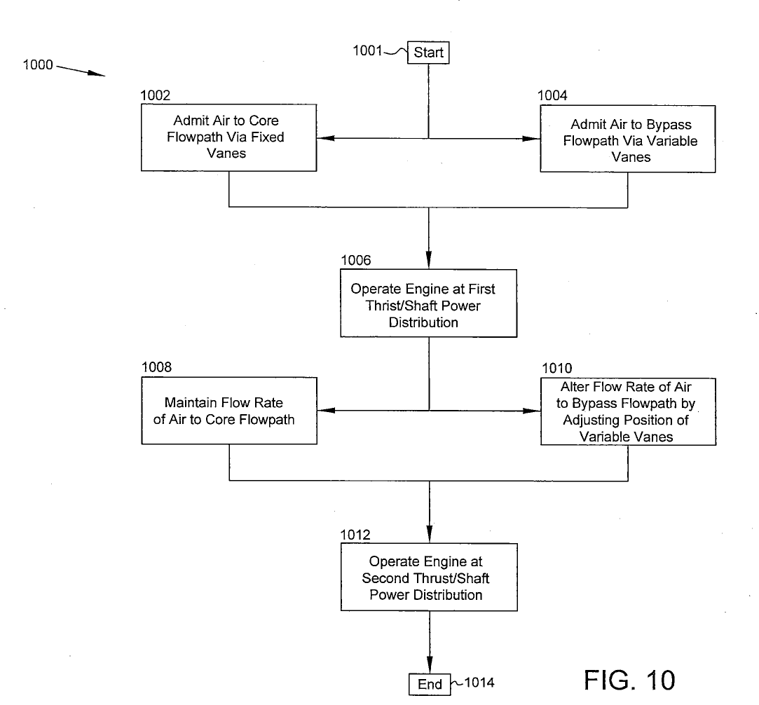

FIG. 10 is a flow diagram of a method 1000 of operating a gas turbine engine with radially-split inlet guide vanes. The method 1000 begins at step 1001 and proceeds simultaneously to steps 1002 and 1004. At step 1002 air is admitted into the core flowpath via the fixed portion of the radially-split inlet guide vanes. Air can be admitted into the core flowpath at a first volumetric flow rate. At step 1004 air is admitted into the bypass flowpath via the variable portion of the radially-split inlet guide vanes. Air can be admitted into the bypass flowpath at a second volumetric flow rate, which may or may not be the same as the first volumetric flow rate.

Method 1000 then proceeds to step 1006, where the gas turbine engine is operated at a first distribution between thrust and shaft power. This first distribution can include full thrust (zero shaft power), full shaft power (zero thrust), or a continuous range between full thrust and full shaft power in which the power output of the engine is distributed between thrust and shaft power. The position of the variable portion can thus be described as a full thrust position in which the variable portion provides maximum air flow to the bypass flowpath, a full shaft power position in which the variable portion is shut to secure air flow to the bypass flowpath, and a continuous range of positions between full thrust and full shaft power. In some embodiments the shaft of the gas turbine engine is connected to a lift fan, a propeller, a generator, or other device or system which requires or receives shaft power.

At step 1008, the flow rate of air admitted to the core flowpath is maintained simultaneous with step 1010, where the flow rate of air admitted into the bypass flowpath is altered by adjusting the position of the variable portion of the radially-split inlet guide vanes. In some embodiments, the position of the variable portion is adjusted by articulating a unitary airfoil around an axis of articulation. In other embodiments, a variable portion comprises a fixed strut and rotatable flap which is articulated around an axis of articulation. In some embodiments, an actuator or actuation ring is used to adjust the position of the variable portion. As an example, step 1010 could comprise articulating a unitary airfoil to reduce the effective surface area of inlet fan duct 14, resulting in less intake of inlet air into the bypass flowpath and subsequently in less thrust output from the gas turbine engine. Further, in some embodiments step 1010 comprises a first sub-step of coarsely adjusting the flow rate of air admitted into the bypass flowpath by making a first relatively larger change in the position of the variable portion, followed by a second sub-step of finely adjusting the flow rate of air admitted into the bypass flowpath by making a second relatively smaller change in the position of the variable portion. In embodiments having a least two sets of radially-split guide vanes, such as the embodiments illustrated in FIGS. 12 and 14, the first sub-step of coarsely adjusting the flow rate of air admitted into the bypass flowpath can be made by a first set of radially-split guide vanes and the second sub-step of finely adjusting the flow rate of air admitted into the bypass flowpath can be made by a first set of radially-split guide vanes.

At step 1012 the engine is operated at a second distribution between thrust and shaft power. This second distribution can include full thrust (zero shaft power), full shaft power (zero thrust), or a continuous range between full thrust and full shaft power in which the power output of the engine is distributed between thrust and shaft power.

Method 1000 ends at step 1014.

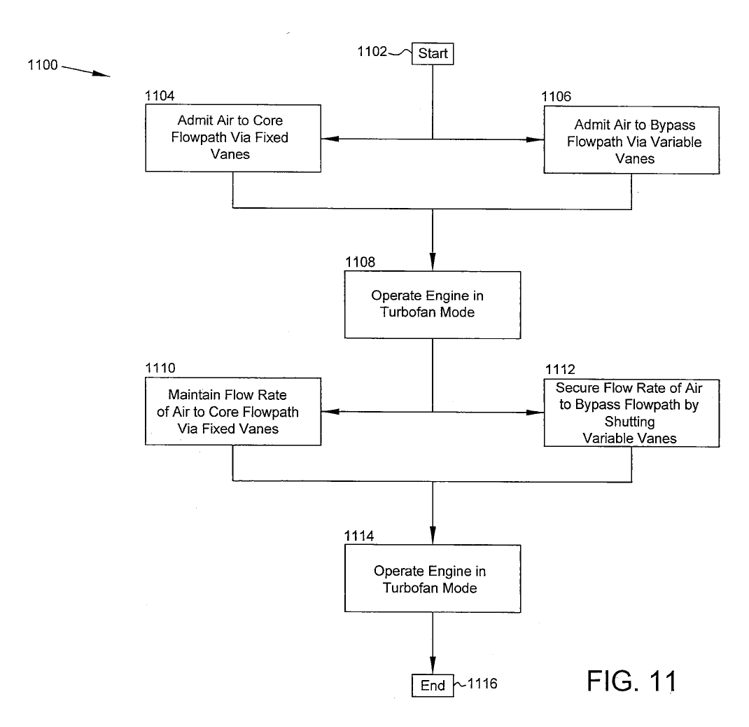

FIG. 11 is a flow diagram of a method 1100 of transitioning a gas turbine engine with radially-split inlet guide vanes from turbofan mode to turboshaft mode. The method 1100 begins at step 1102 and proceeds simultaneously to steps 1104 and 1106. At step 1104 air is admitted into the core flowpath via the fixed portion of the radially-split inlet guide vanes. Air can be admitted into the core flowpath at a first volumetric flow rate. At step 1106 air is admitted into the bypass flowpath via the variable portion of the radially-split inlet guide vanes. Air can be admitted into the bypass flowpath at a second volumetric flow rate, which may or may not be the same as the first volumetric flow rate.

Method 1100 then proceeds to step 1108, where the gas turbine engine is operated in turbofan mode. When it is desired to transition the gas turbine engine from turbofan mode to turboshaft mode, the method 1100 proceeds simultaneously to steps 1110 and 1112. In some applications, the gas turbine engine is affixed to an aircraft which is transitioning from a horizontal mode of flight to a vertical mode of flight, creating the desire to transition the gas turbine engine from turbofan mode to turboshaft mode.

At step 1110, the flow rate of air admitted to the core flowpath is maintained via the fixed portions of the radially-split inlet guide vanes. At step 1112, the flow rate of air admitted into the bypass flowpath is substantially reduced to zero by adjusting the position of the variable portion of the radially-split inlet guide vanes to secure flow of air into the bypass flowpath. In some embodiments, the position of the variable portion is adjusted by articulating a unitary airfoil around an axis of articulation. In other embodiments, a variable portion comprises a fixed strut and rotatable flap which is articulated around an axis of articulation. In some embodiments, an actuator or actuation ring is used to adjust the position of the variable portion.

At step 1114 the engine is operated in turboshaft mode. Method 1100 ends at step 1116.

The disclosed gas turbine engine having radially-split inlet guide vanes provides numerous advantages over the prior art. In applications requiring a gas turbine engine to operate in both turbofan mode (producing thrust) and turboshaft mode (producing shaft power), the disclosed engine allows for transitioning between these modes or balancing operation simultaneously between these two modes. As the variable portion of the inlet guide vanes are shut bypass flow is reduced, causing a reduction in thrust while maintaining or transferring engine output to shaft power. The engine core is able to maintain a steady power output (including maximum power) while reducing engine thrust. Similarly, thrust can be significantly increased in a near-instantaneous manner by altering the variable portions of the inlet guide vanes from a closed or near-closed position to a fully open position. This increase in thrust is more rapid than would be achievable using mechanical clutches between the turbine and the fan unit, and presents advantages in applications requiring such rapid changes in thrust, for example during a rapid egress of a military aircraft. The disclosed radially-split inlet guide vanes can be integrated into gas turbine engine designs which use a single stage fan or a two-stage fan, and which use any number of engine shafts. A further advantage is that fan blades of the turbofan engine are not required to be shrouded, segmented, or otherwise include devices which physically separate airflow into core and bypass flows.

Although examples are illustrated and described herein, embodiments are nevertheless not limited to the details shown, since various modifications and structural changes may be made therein by those of ordinary skill within the scope and range of equivalents of the claims.

What is claimed is:

1. An apparatus for the control of fluid flow in a gas turbine engine comprising:
a first plurality of inlet guide vanes disposed upstream of a fan, a compressor, a combustor, and a turbine;
at least one airflow splitter adapted to split air admitted through said first plurality of inlet guide vanes into a core airflow which flows through said fan, said compressor, said combustor, and said turbine and a bypass airflow which flows through said fan;
wherein said first plurality of inlet guide vanes comprise a radially-inward first portion adapted to direct air admitted through said first plurality of inlet guide vanes to said core airflow and a radially-outward second portion adapted to direct air admitted through said first plurality of inlet guide vanes to said bypass airflow, and wherein said first portion comprises a fixed vane and said second portion comprises a variable vane.

2. The apparatus of claim 1 further comprising an actuator adapted to adjust the position of said second portion.

3. The apparatus of claim 2 wherein said variable vane comprises a fixed strut and a rotatable flap, and wherein the orientation of said variable vane is varied by articulating the rotatable flap relative to the fixed strut.

4. The apparatus of claim 3 wherein said variable vane comprises an airfoil and the orientation of said variable vane is varied by articulating said airfoil about a radial axis thereof.

5. The apparatus of claim 4 wherein a protrusion extends from said radially-outward second portion into said radially-inward first portion to provide a point of articulation for said radially-outward second portion.

6. The apparatus of claim 1 wherein said fan is a two-stage fan comprising an upstream set of fan blade and a downstream set of fan blades.

7. The apparatus of claim 6 further comprising a second plurality of radially-split inlet guide vanes disposed downstream from said upstream set of fan blades and upstream from said downstream set of fan blades.

8. The apparatus of claim 7 further comprising a second plurality of radially-split inlet guide vanes disposed downstream from said upstream set of fan blades and said downstream set of fan blades.

9. A gas turbine engine comprising:
an air inlet;
at least one airflow splitter adapted to split an inlet airflow into a bypass airflow and a core airflow which flows through a core comprising a compressor, a combustor, and a turbine, wherein said bypass airflow bypasses said core;
a fan disposed between said air inlet and said core;
wherein said air inlet comprises a plurality of radially-split inlet guide vanes comprising a fixed portion and a variable portion, said fixed portion directing inlet airflow into said core airflow and said variable portion controlling the flow rate of inlet airflow into said bypass airflow.

10. The engine of claim 9 wherein said fixed portion is radially-inward from said variable portion and said variable portion is radially-outward from said fixed portion.

11. The engine of claim 10 wherein said variable portion is continuously variable between a full turbothrust position and a full turboshaft position.

12. The engine of claim 11 further comprising an actuator adapted to vary the orientation of said variable portion wherein said actuator is adapted to reduce said bypass airflow while maintaining a constant core airflow.

13. The engine of claim 9 further comprising a set of radially-split guide vanes disposed aft of said plurality of radially-split inlet guide vanes.

14. The engine of claim 9 further comprising a shaft connected between said turbine and one or more of a lift rotor, a propeller or a generator.

15. The engine of claim 14 wherein altering said variable portion to reduce bypass airflow transfers power from thrust to said shaft connected between said turbine and one or more of a lift rotor, a propeller or a generator.

16. A method of altering the thrust of a gas turbine engine having a core flowpath through an air inlet, a fan, a compressor, a combustor, and a turbine and a bypass flowpath through said air inlet and said fan, the method comprising the steps of:
admitting a first volumetric flow rate of air into said core flowpath via a first portion of said air inlet comprising a plurality of fixed vanes;
admitting a second volumetric flow rate of air into said bypass flowpath via a second portion of said air inlet comprising a plurality of variable vanes; and
altering the inlet geometry of said plurality of variable vanes to alter said second volumetric flow rate of air admitted into said bypass flowpath while maintaining said first volumetric flow rate of air admitted into said core flowpath constant.

17. The method of claim 16 wherein said plurality of variable vanes are continuously variable between a first fully powered position and a second fully depowered position.

18. The method of claim 16 wherein the step of altering the inlet geometry comprises manipulating an actuator connected to said plurality of variable vanes causing a reduction in said second volumetric flow rate of air admitted into said bypass flowpath.

19. The method of claim 18 wherein said gas turbine engine is affixed to an aircraft and wherein said step of altering the inlet geometry is performed as the aircraft transitions between horizontal and vertical modes of flight.

20. The method of claim 16, wherein said step of altering the inlet geometry further comprises the steps of:
coarsely adjusting said second volumetric flow rate of air admitted into said bypass flowpath; and
finely adjusting said second volumetric flow rate of air admitted into said bypass flowpath.
